(19) United States
(12) Patent Application Publication
(10) Pub. No.: US 2022/0324042 A1
(43) Pub. Date: Oct. 13, 2022

(54) Machining Tool, In Particular Oscillating Machining Tool

(71) Applicant: Robert Bosch GmbH, Stuttgart (DE)

(72) Inventors: Michael Landt, Glenview, IL (US); Arvind Gopi, Prospect Heights, IL (US); Milan Bozic, Luterbach (CH); Walter Bernardi, Highland Park, IL (US); Daniel Schadegg, Buffalo Grove, IL (US)

(21) Appl. No.: 17/634,443

(22) PCT Filed: Aug. 13, 2020
(86) PCT No.: PCT/EP2020/072798

§ 371 Date: Feb. 10, 2022

(30) Foreign Application Priority Data
Aug. 16, 2019 (DE) 10 2019 212 302.3

(51) Int. Cl. B23D 61/00

(52) U.S. Cl. CPC B23D 61/006

(57) ABSTRACT

An oscillating working tool includes a main body with a coupling interface in a receiving region of the main body that is different from a working region of the main body. The at least one coupling interface is configured to couple to a tool receiver of a power tool. The working tool further includes a further coupling interface, arranged in the receiving region and configured to couple to a further tool receiver, different from the tool receiver, of a further power tool. The coupling interface and the further coupling interface realize at least two different coupling planes, in each of which at least one axial securing element of the at least one coupling interface and/or of the further coupling interface is arranged.

### PRIOR ART

There has already been proposed a working tool, in particular an oscillating working tool, comprising at least one main body, comprising at least one coupling interface, arranged on the main body in a receiving region of the main body that is different from a working region of the main body, for coupling to a tool receiver of a power tool, and comprising at least one further coupling interface, arranged in the receiving region on the main body, for coupling to a further tool receiver, in particular realized differently from the tool receiver, of a further power tool.

### DISCLOSURE OF THE INVENTION

The invention is based on a working tool, in particular an oscillating working tool, comprising at least one main body, comprising at least one coupling interface, arranged on the main body in a receiving region of the main body that is different from a working region of the main body, for coupling to a tool receiver of a power tool, and comprising at least one further coupling interface, arranged in the receiving region on the main body, for coupling to a further tool receiver, in particular realized differently from the tool receiver, of a further power tool.

It is proposed that the coupling interface and the further coupling interface realize at least two different coupling planes, in each of which at least one axial securing element of the coupling interface and/or of the further coupling interface is arranged.

Preferably, the working tool is realized as an oscillating working tool. Alternatively, it is conceivable for the working tool to be realized as a rotary-action working tool, as a pendulum-action working tool or as another working tool considered appropriate by persons skilled in the art. Preferably, the working tool is realized as a cutting tool, a grinding tool, a sawing tool or the like. The working tool is preferably designed for use with the power tool, in particular with an oscillating power tool. In particular, the oscillating power tool is designed to drive the working tool to execute a motion, in particular an oscillatory motion. “Designed” is to be understood to mean, in particular, specially configured and/or equipped. That an object is designed for a particular function, is to be understood to mean, in particular, that the object fulfils and/or executes this particular function in at least one application state and/or operating state.

The main body of the working tool is preferably made of a metal. Alternatively, it is conceivable for the main body to be made of a composite material, of a ceramic or of another material considered appropriate by persons skilled in the art. The working region of the main body is in particular a region of the main body in which the main body is designed, in particular shaped, for performing work on a workpiece, for example has a cutting edge, and/or in which the main body can be connected and/or is connected to a working part of the working tool designed for performing work on a workpiece. In particular, the working part may be such that it can be welded, riveted or screwed to the main body, or connected to the main body in another manner considered appropriate by persons skilled in the art. Preferably, the working region has a plane of main extent that is different from a plane of main extent of the receiving region, in particular that extends offset from the plane of main extent of the receiving region. A “plane of main extent” of an object is to be understood to mean, in particular, a plane that is parallel to a largest lateral surface of a smallest notional cuboid that only just completely encloses the object, and that in particular passes through the mid-point of the cuboid. Preferably, the plane of main extent of the receiving region and the plane of main extent of the working region are parallel to each other. “Parallel” is to be understood to mean, in particular, an alignment of a direction relative to a reference direction, in particular in one plane, the direction deviating from the reference direction by, in particular, less than 8°, advantageously less than 5°, and particularly advantageously less than 2°.

Preferably, the working tool comprises two coupling interfaces. Alternatively, it is conceivable for the working tool to have a number of coupling interfaces that is other than two, for example three, four, five or more coupling interfaces. Preferably, the coupling interfaces are realized differently from one another, in particular for coupling to mutually differently realized tool receivers of different power tools. Preferably, the coupling interface and the further coupling interface each realize a single coupling plane. Alternatively, it is conceivable for the coupling interface and/or the further coupling interface to realize a plurality of coupling planes. Preferably, there is at least one axial securing element of the coupling interface arranged in the coupling plane of the coupling interface, and at least one axial securing element of the further coupling interface arranged in the coupling plane of the further coupling interface. Preferably, the coupling interface comprises a single axial securing element arranged in the coupling plane of the coupling interface, and the further coupling interface comprises a single axial securing element arranged in the coupling plane of the further coupling interface. The axial securing elements are in particular designed to secure the main body to the tool receiver, along a direction parallel to an output axis of the tool receiver of the power tool. Preferably, the axial securing element of at least one of the coupling interfaces is realized differently from torque transmission elements of the at least one of the coupling interfaces, which are provided for transmitting torque from the tool receiver to the main body.

Preferably, the coupling plane of the coupling interface and the coupling plane of the further coupling interface extend offset from each other and/or tilted with respect to each other by angle that is other than 0° and 360°. Preferably, the coupling plane of the coupling interface and the coupling plane of the further coupling interface extend without any points of mutual intersection. Preferably, the coupling plane of the coupling interface and the coupling plane of the further coupling interface extend parallel to each other. Preferably, the coupling plane of the coupling interface and/or the coupling plane of the further coupling interface extend/extends parallel to the plane of main extent of the receiving region. In particular, the coupling plane of the coupling interface or the coupling plane of the further coupling interface corresponds to the plane of main extent of the receiving region. Preferably, the coupling plane of the coupling interface and/or the coupling plane of the further coupling interface extend/extends parallel to the plane of main extent of the working region. Preferably, at least one of the coupling interfaces is closed in itself, in particular in a star shape, in at least one plane extending parallel to the plane of main extent of the receiving region, in particular at least in the plane of main extent of the receiving region.

The design of the working tool according to the invention allows it to be coupled to and used with different power tools. It is possible to provide a working tool having a plurality of coupling interfaces, each of which has an advantageously large contact surface for coupling to a power tool. Coupling interfaces can be provided that enable advantageously secure fastening to a tool receiver, advantageously efficient transmission of torque and/or advantageously low risk of breakage. It is possible to provide a working tool having a plurality of coupling interfaces that are advantageously widely accessible for a tool receiver of a power tool for the purpose of realizing a coupling to the power tool in a manner that is convenient for the user. It is advantageously possible to provide a low-wear, efficient working tool that is safe and convenient for the user.

It is furthermore proposed that the coupling interface and the further coupling interface have mutually separate axial securing elements. In particular, the axial securing element of the coupling interface extends outside the coupling plane of the further coupling interface, and the axial securing element of the further coupling interface extends outside the coupling plane of the coupling interface. Preferably, the axial securing element of the coupling interface and the axial securing element of the further coupling interface are realized, in particular shaped, differently from each other. In particular, the axial securing element of the coupling interface and the axial securing element of the further coupling interface are realized without any common sub-portions. In particular, a tool receiver, when coupled to the coupling interface, is arranged without contact to the axial securing element of the further coupling interface and, when coupled to the further coupling interface, without contact to the axial securing element of the coupling interface. Advantageously, coupling interfaces can be provided that enable tool-holder-specific axial securing. It is advantageously possible to achieve coupling to different power tools in a manner that is particularly safe for the user.

It is also proposed that the coupling interface and the further coupling interface be spaced from each other. Preferably, the coupling interface and the further coupling interface, in particular at least the axial securing element of the coupling interface and the axial securing element of the further coupling interface, are spaced from each other at least along a direction perpendicular to the plane of main extent of the receiving region, to the coupling plane of the coupling interface and/or to the coupling plane of the further coupling interface. The term “perpendicular” is intended in particular to define an orientation of a direction relative to a reference direction, wherein the direction and the reference direction, in particular as viewed in a projection plane, enclose an angle of 90° and the angle has a maximum deviation of in particular less than 8°, advantageously less than 5° and particularly advantageously less than 2°. Preferably, the coupling interface and the further coupling interface, in particular at least the axial securing element of the coupling interface and the axial securing element of the further coupling interface, are spaced from one another at least along a direction parallel to the plane of main extent of the receiving region, to the coupling plane of the coupling interface and/or to the coupling plane of the further coupling interface. Preferably, the coupling interface and the further coupling interface are realized without any common elements, in particular axial securing elements and torque transmission elements. Advantageously, coupling interfaces can be provided that are particularly freely accessible and particularly resistant to fracture.

It is furthermore proposed that the coupling interface and the further coupling interface be arranged so as to overlap, at least portionally. Preferably, the coupling interface and the further coupling interface are arranged so as to overlap, at least portionally, at least as viewed along one direction, in particular along a coupling direction, perpendicular to the coupling planes. In particular, the coupling interface and the further coupling interface are arranged spaced from each another at least along the direction, in particular along the coupling direction, perpendicular to the coupling planes. Preferably, the coupling interface and the further coupling interface are arranged parallel to the coupling planes along a direction, in particular along a plurality of different directions, without being spaced from each other. Advantageously, a particularly compactly realized working tool can be provided.

It is additionally proposed that the main body be shaped in the manner of a bellows, in particular to realize an at least portionally overlapping arrangement of the coupling interface and the further coupling interface. In particular, the main body in the receiving region is shaped in the manner of a bellows. In particular, the main body in the receiving region has a shaped region by which the coupling interface and the further coupling interface are spaced apart from each another. Preferably, the main body is shaped by an angle of at least 90°.

Preferably, the main body is shaped in a rounded manner. In particular, the main body does not have any sharp bend in the shaped region. In the shaped region, the main body is preferably realized in a manner substantially similar to a shaped portion of a bellows. Advantageously, a working tool can be provided that is particularly compact and resistant to fracture.

It is furthermore proposed that the coupling interface and the further coupling interface be arranged coaxially with respect to each other. In particular, the axial securing element of the coupling interface and the axial securing element of the further coupling interface are arranged congruently with each other as viewed along the direction, in particular along the coupling direction, perpendicular to the coupling planes. In particular, torque transmission elements of the coupling interface and torque transmission elements of the further coupling interface can be arranged congruently with each other as viewed parallel to the direction, in particular parallel to the coupling direction, perpendicular to the coupling planes. Preferably, an output axis of a tool receiver coupled to the coupling interface is coaxial, in particular congruent, with an output axis of a tool receiver coupled to the further coupling interface. Advantageously, a distance between the coupling interfaces and a cutting edge of the working tool that is advantageous for oscillatory excitation can be provided irrespective of the coupled tool receiver.

It is also proposed that the coupling interface and the further coupling interface be arranged in such a manner that the coupling interface and the further coupling interface can be coupled to a power tool in mutually antiparallel coupling directions. The term “antiparallel” is intended in particular to define an alignment of a direction relative to a reference direction, wherein the direction and the reference direction, in particular as viewed in a projection plane, enclose an angle of 180° and the angle has a maximum deviation of in particular less than 8°, advantageously less than 5° and particularly advantageously less than 2°. Preferably, the coupling interface and the further coupling interface are arranged in such a manner that the coupling interface and the further coupling interface can be coupled to a power tool in mutually anticoaxial coupling directions. In particular, at least one of the coupling interfaces may have a transverse extent, in particular a side wall, that extends beyond a material thickness of the main body, in particular in the receiving region. Preferably, the transverse extent, in particular the side wall, of the at least one of the coupling interfaces extends along a direction away from the respectively other of the coupling interfaces.

A “transverse extent” of the coupling interface and/or of the further coupling interface is to be understood to mean, in particular, an extent of the coupling interface and/or of the further coupling interface that is transverse, in particular perpendicular, to the plane of main extent of the receiving region, to the coupling plane of the coupling interface and/or to the coupling plane of the further coupling interface. Preferably, the coupling interface and the further coupling interface, arranged so as to overlap at least portionally, are arranged in such a manner that the coupling interface and the further coupling interface can be coupled to a power tool in mutually antiparallel coupling directions. It is advantageously possible to provide a working tool having a plurality of coupling interfaces that are conveniently accessible for coupling to a power tool.

It is further proposed that the main body delimit at least one recess that spaces the coupling interface and the further coupling interface from each other, at least in a direction parallel to the coupling planes. Preferably, the recess is arranged in the receiving region, in particular extends in the plane of main extent of the receiving region. In particular, the recess extends in the coupling plane of the further coupling interface. Preferably, the coupling plane of the further coupling interface and the plane of main extent of the receiving region coincide. In particular, the further coupling interface has a transverse extent corresponding to a material thickness of the main body, in particular in the receiving region. Preferably, the recess is circular. Alternatively, it is conceivable for the recess to be elliptical, polygonal or realized in another manner considered appropriate by persons skilled in the art. Preferably, the coupling interface and/or the further coupling interface are/is arranged directly adjacent to the recess, in particular on opposite sides of the recess, in the direction parallel to the coupling planes. It is advantageously possible to achieve a separation of the coupling interfaces in order to realize a visual differentiation of the coupling interfaces that is convenient for the user.

It is additionally proposed that the recess serve as a combined tool-receiver feed opening for the coupling interface and for the further coupling interface. In particular, the tool receiver can be guided along a direction, in particular along a coupling direction, perpendicular to the plane of main extent of the receiving region and/or to the coupling planes, at least portionally, through the recess. In particular, the tool receiver arranged at least portionally in the recess is displaceable along and/or contrary to the direction that is parallel to the coupling planes, in particular perpendicularly in relation to the coupling direction, in particular for the purpose of engagement with the coupling interface and/or with the further coupling interface. Preferably, the recess merges into the axial securing element of the coupling interface and/or into the axial securing element of the further coupling interface, in particular along and/or contrary to the direction that is parallel to the coupling planes. It is advantageously possible to achieve a high degree of accessibility of the coupling interfaces that is convenient to the user.

It is furthermore proposed that the coupling interface and/or the further coupling interface, together with at least one shaped portion of the main body, delimit at least one recess in the main body. Preferably, the shaped portion of the main body, in particular along the direction that is parallel to the coupling planes, is arranged between the coupling interface and the further coupling interface. In particular, the main body in the shaped portion extends transversely with respect to the plane of main extent of the receiving region and/or to the coupling planes. In particular, the main body in the shaped portion extends at an angle of at least 5°, preferably at least 10°, particularly preferably at least 20° and very particularly preferably at least 30° relative to the plane of main extent of the receiving region and/or to the coupling planes. In particular, the main body in the shaped portion extends at an angle of at most 90°, preferably of at most 75°, particularly preferably of at most 60° and most particularly preferably of at most 45° relative to the plane of main extent of the receiving region and/or to the coupling planes. Preferably, the shaped portion spaces the coupling planes from each other along a direction perpendicular to the coupling planes. Preferably the recess extends in the shaped portion. In particular, the recess is directly adjacent to at least one of the coupling interfaces arranged on the shaped portion. The recess is designed, in particular, to expose the at least one of the coupling interfaces for coupling to the tool receiver. In particular, the recess extends between the at least one of the coupling interfaces and the plane of main extent of the receiving region. It is advantageously possible to provide a working tool that is particularly easy to activate and has mutually separate coupling interfaces that are accessible in a manner convenient for the user.

It is also proposed that at least one of the coupling interfaces have at least one torque transmission element extending transversely with respect to the coupling planes. Preferably, the coupling interfaces comprise a plurality of torque transmission elements. Preferably, the torque transmission elements of a single one of the coupling interfaces extend transversely with respect to the coupling planes. In particular, the torque transmission elements of the other of the coupling interfaces extend parallel to the coupling planes, in particular are arranged in the coupling plane of the other of the coupling interfaces. In particular, the coupling interface having the torque transmission elements extending transversely with respect to the coupling planes may have further torque transmission elements extending parallel to the coupling planes, in particular arranged in the coupling plane of the coupling interface. Preferably, the torque transmission elements extending transversely with respect to the coupling planes are realized as protrusions and/or indentations in the side wall of the at least one of the coupling interfaces. Preferably, the torque transmission elements and/or the further torque transmission elements extending parallel to the coupling planes are realized as recesses, in particular as elongate holes, in the main body and/or in at least one cover wall of at least one of the coupling interfaces. Preferably, the torque transmission elements extending transversely with respect to the coupling planes extend along the side wall of the at least one of the coupling interfaces, in particular are formed by the side wall. In particular, the side wall is star-shaped and in particular describes alternating indentations and protrusions. In particular, the indentations and protrusions in the side wall realize the torque transmission elements. It is advantageously possible to achieve optimal transmission of torque to the working tool in order to realize a high degree of user convenience.

The invention is furthermore based on a working system comprising at least one working tool according to the invention and comprising at least one power tool, in particular comprising at least one oscillating power tool, and/or comprising at least one further power tool, in particular comprising a further oscillating power tool, wherein the power tool and/or the further power tool have/has at least one tool receiver to which the working tool can be coupled by means of the coupling interface, wherein the power tool and/or the further power tool have/has at least one further tool receiver that is realized differently from the tool receiver and to which the working tool can be coupled by means of the further coupling interface. Preferably, the working system comprises the power tool and the further power tool, which have different tool receivers. Alternatively, it is conceivable for the working system to comprise a single power tool that has at least two different tool receivers, or for the working system to comprise the power tool and the further power tool, wherein the power tool and/or the further power tool each has/have at least two different tool receivers. Preferably, the working tool may be such that it can be coupled to two different tool receivers by means of one of the coupling interfaces, for example to the tool receiver of the power tool and to the tool receiver of at least one additional power tool. Preferably, the working system may have a plurality of working tools, for example a sawing tool, a cutting tool and a grinding tool. It is advantageously possible to provide a flexible working system that is convenient and safe for the user.

The invention is additionally based on a method for the production of a working tool, in particular a working tool according to the invention.

It is proposed that in at least one method step at least two, in particular different, coupling interfaces be arranged on the main body, in a receiving region of the main body that is different from a working region of at least one main body of the working tool, such that the coupling interfaces realize at least two different coupling planes, in each of which at least one axial securing element of the coupling interface and/or of the further coupling interface is arranged. Preferably, the coupling interfaces are arranged on the main body with different transverse extents transverse to the plane of main extent of the receiving region. In particular, the coupling interfaces are realized integrally with the main body. “Integrally” is to be understood to mean, in particular, formed in one piece. Preferably, this one piece is produced from a single blank, a mass and/or a casting, particularly preferably in an injection molding process, in particular a single-component and/or multi-component injection molding process. Preferably, the main body and the coupling interfaces are formed from a common blank, in particular from a metal, preferably from a steel. In particular, the coupling interfaces are formed by a forming process, by a casting process, by a stamping process, by a milling process or the like. Alternatively, it is conceivable for the coupling interfaces to be formed integrally with the main body by a 3D printing process. Advantageously, precise production of the working tool can be achieved.

It is furthermore proposed that in at least one method step at least one recess, in particular realized as a tool-receiver feed opening, be made in the main body and/or in at least one of the coupling interfaces by means of a laser-cutting and/or water-jet cutting process. Preferably, the at least one recess, in particular realized as a tool-receiver feed opening, is made in the main body and/or in at least one side wall of at least one of the coupling interfaces. In particular, at least a portion of the main body and/or at least a portion of the at least one side wall is cut out by means of a laser beam and/or by means of a water jet in order to realize the at least one recess, in particular realized as a tool-receiver feed opening. It is advantageously possible to form a precisely defined recess, in particular realized as a tool-receiver feed opening.

The working tool according to the invention, the working system according to the invention and/or the method according to the invention are/is not in this case intended to be limited to the application and embodiment described above. In particular, in order to fulfill a principle of function described herein, the working tool according to the invention, the working system according to the invention and/or the method according to the invention may have individual elements, components and units, and method steps, that differ in number from a number stated herein. Moreover, in the case of the value ranges specified in this disclosure, values lying within the stated limits are also to be deemed as disclosed and applicable in any manner.

### DRAWINGS

Further advantages are given by the following description of the drawings. Ten exemplary embodiments of the invention are represented in the drawings. The drawings, the description and the claims contain numerous features in combination. Persons skilled in the art will also expediently consider the features individually and combine them to create appropriate further combinations.

In the drawings:

FIG. 1 shows a working system according to the invention, in a perspective schematic representation,

FIG. 2 shows working tool according to the invention of the working system according to the invention from FIG. 1, in a perspective schematic representation.

FIG. 3 shows the working tool according to the invention from FIG. 2, when coupled to a power tool of the working system according to the invention from FIG. 1, in a perspective schematic representation,

FIG. 4 shows the working tool according to the invention from FIG. 2, when coupled to a further power tool of the working system according to the invention from FIG. 1, in a perspective schematic representation,

FIG. 5 shows a first alternative working tool according to the invention, in a perspective schematic representation,

FIG. 6 shows a second alternative working tool according to the invention, in a perspective schematic representation,

FIG. 7 shows a third alternative working tool according to the invention, in a perspective schematic representation,

FIG. 8 shows a fourth alternative working tool according to the invention, in a perspective schematic representation,

FIG. 9 shows a fifth alternative working tool according to the invention, in a perspective schematic representation,

FIG. 10 shows a sixth alternative working tool according to the invention, in a perspective schematic representation,

FIG. 11 shows a seventh alternative working tool according to the invention, in a perspective schematic representation,

FIG. 12 shows an eighth alternative working tool according to the invention, in a perspective schematic representation, and

FIG. 13 shows a ninth alternative working tool according to the invention, in a perspective schematic representation.

### DESCRIPTION OF THE EXEMPLARY EMBODIMENTS

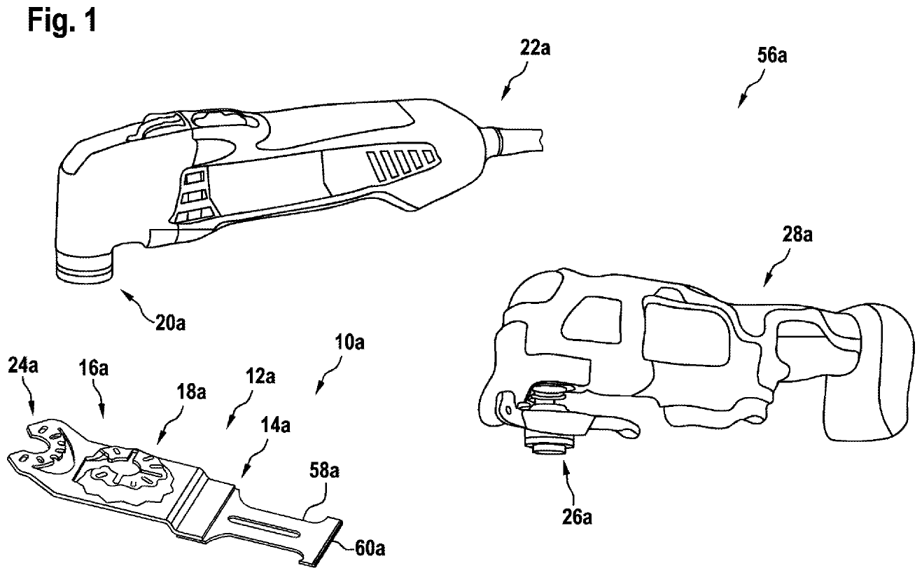

FIG. 1 shows a working system 56a in a perspective schematic representation. In particular, the working system 56a comprises at least one working tool 10a, in particular at least one oscillating working tool, and at least one power tool 22a, in particular at least one oscillating power tool, and/or at least one further power tool 28a, in particular a further oscillating power tool.

Preferably, the working tool 10a comprises at least one main body 12a, at least one coupling interface 18a, arranged on the main body 12a in a receiving region 16a of the main body 12a that is different from a working region 14a of the main body 12a, for coupling to a tool receiver 20a of a power tool 22a, in particular the aforementioned, and at least one further coupling interface 24a, arranged in the receiving region 16a on the main body 12a, for coupling to a further tool receiver 26a, in particular realized differently from the tool receiver 20a, of a further power tool 28a, in particular the aforementioned. Preferably, the power tool 22a and/or the further power tool 28a have/has at least one tool receiver 20a, in particular the aforementioned, to which the working tool 10a can be coupled by means of the coupling interface 18a, wherein the power tool 22a and/or the further power tool 28a have/has at least one further tool receiver 26a, in particular the aforementioned, realized differently from the tool receiver 20a, to which the working tool 10a can be coupled by means of the further coupling interface 24a. Preferably, the working system 56a comprises the power tool 22a and the further power tool 28a, which have different tool receivers 20a, 26a. Alternatively, it is conceivable for the working system 56a to comprise a single power tool 22a, 28a having at least two different tool receivers 20a, 26a, or for the working system 56a to comprise the power tool 22a and the further power tool 28a, wherein the power tool 22a and/or the further power tool 28a each has/has at least two different tool receivers 20a, 26a. Preferably, the working tool 10a may be such that it can be coupled to two different tool receivers 20a, 26a by means of one of the coupling interfaces 18a, 24a, for example to the tool receiver 20a of the power tool 22a and to a tool receiver of at least one additional power tool (not represented here). Preferably, the working system 56a may comprise a plurality of working tools 10a, for example a sawing tool, a cutting tool and a grinding tool.

In the present exemplary embodiment, the working system 56a exemplarily comprises the single working tool 10a, which is exemplarily realized as a sawing tool. The power tools 22a, 28a are preferably realized as oscillating power tools, in particular as oscillating multifunction power tools. The power tools 22a, 28a are realized, in particular, as hand-held power tools. The power tools 22a, 28a are designed, in particular, for driving the working tool 10a in an oscillating manner. In the present exemplary embodiment, the power tool 22a exemplarily comprises the single tool receiver 20a for coupling to the coupling interface 18a of the working tool 10a. In the present exemplary embodiment, the further power tool 28a exemplarily comprises the single tool receiver 26a, which is realized differently from the tool receiver 20a of the power tool 22a, for coupling to the further coupling interface 24a of the working tool 10a.

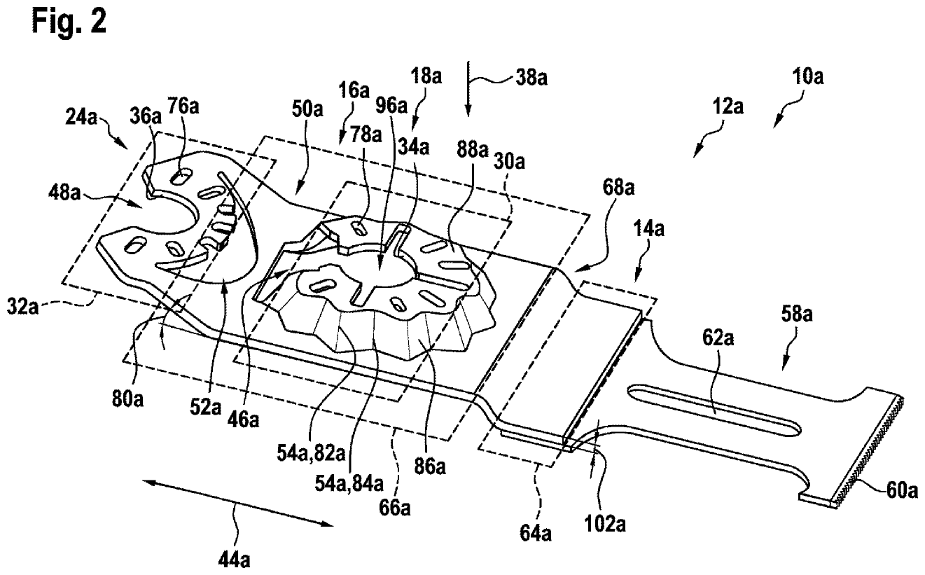

FIG. 2 shows the working tool 10a of the working system 56a from FIG. 1, in a perspective schematic representation. Preferably, the coupling interface 18a and the further coupling interface 24a realize at least two different coupling planes 30a, 32a, in each of which at least one axial securing element 34a, 36a of the coupling interface 18a and/or the further coupling interface 24a is arranged. Preferably, the working tool 10a is realized as an oscillating working tool. Alternatively, it is conceivable for the working tool 10a to be realized as a rotary-action working tool, as a pendulum-action working tool or as another working tool considered appropriate by persons skilled in the art. Preferably, the working tool 10a is realized as a cutting tool, as a grinding tool, as a sawing tool or the like, in the present exemplary embodiment exemplarily as a sawing tool. The working tool 10a is preferably designed for use with the power tool 22a, in particular with the oscillating power tool, and with the further power tool 28a, in particular with the further oscillating power tool. In particular, the power tool 22a and the further power tool 28a are designed to drive the working tool 10a to execute a motion, in particular an oscillatory motion.

The main body 12a of the working tool 10a is preferably made of a metal. Alternatively, it is conceivable for the main body 12a to be made of a composite material, of a ceramic or of another material considered appropriate by persons skilled in the art. The working region 14a of the main body 12a is in particular a region of the main body 12a in which the main body 12a is designed, in particular shaped, for performing work on a workpiece, for example has a cutting edge, and/or in which the main body 12a can be connected and/or is connected to a working part 58a of the working tool 10a designed for the purpose of performing work on a workpiece. The working part 58a may in particular be such that it can be welded, riveted or screwed to the main body 12a or connected to the main body 12a in another manner considered appropriate by persons skilled in the art. In the present exemplary embodiment, the working part 58a is exemplarily welded to the main body 12a in the working region 14a. In particular, the working part 58a has a saw edge 60a. In particular, the working part 58a has a recess 62a, in particular an elongate recess, in particular for weight reduction. Preferably, the working region 14a has a plane of main extent 66a that is different from a plane of main extent 64a of the receiving region 16a, in particular extending offset from the plane of main extent 64a of the receiving region 16a. Preferably, the plane of main extent 66a of the receiving region 16a and the plane of main extent 64a of the working region 14a extend parallel to each other. In particular, in a transition region 68a between the receiving region 16a and the working region 14a, the main body 12a extends transversely with respect to the plane of main extent 66a of the receiving region 16a and to the plane of main extent 64a of the working region 14a.

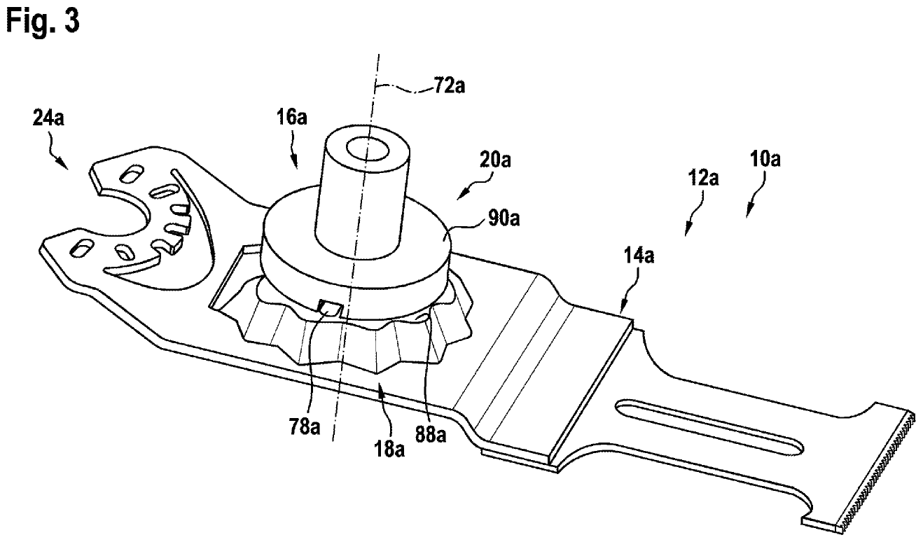

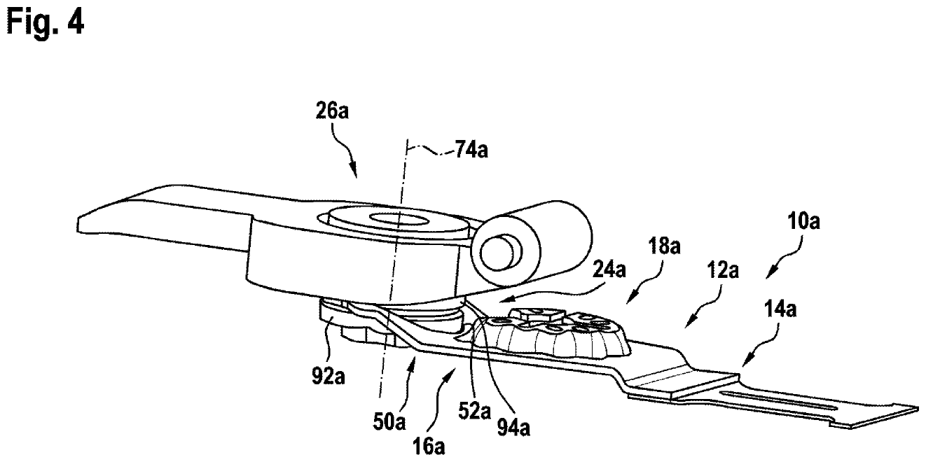

Preferably, the working tool 10a comprises the two coupling interfaces 18a, 24a. Alternatively, it is conceivable for the working tool 10a to have a number of coupling interfaces 18a, 24a that is other than two, for example three, four, five or more coupling interfaces 18a, 24a. Preferably, the coupling interfaces 18a, 24a are realized differently from each other, in particular for coupling to the mutually differently realized tool receivers 20a, 26a of the different power tools 22a, 28a. Preferably, the coupling interface 18a and the further coupling interface 24a each realize a single coupling plane 30a, 32a. Alternatively, it is conceivable for the coupling interface 18a and/or the further coupling interface 24a to realize a plurality of coupling planes 30a, 32a. Preferably, at least one axial securing element 34a of the coupling interface 18a is arranged in the coupling plane 30a of the coupling interface 18a, and at least one axial securing element 36a of the further coupling interface 24a is arranged in the coupling plane 32a of the further coupling interface 24a. Preferably, the coupling interface 18a comprises the single axial securing element 34a arranged in the coupling plane 30a of the coupling interface 18a, and the further coupling interface 24a comprises the single axial securing element 36a arranged in the coupling plane 32a of the further coupling interface 24a. The axial securing elements 34a, 36a are designed, in particular, to secure the main body 12a, along a direction parallel to an output axis 72a of the tool receiver 20a of the power tool 22a and/or to an output axis 74a of the tool receiver 26a of the further power tool 28a, to the tool receiver 20a of the power tool 22a and/or to the tool receiver 26a of the further power tool 28a (cf. FIGS. 3 and 4). Preferably, the axial securing element 34a, 36a of at least one of the coupling interfaces 18a, 24a, in the present exemplary embodiment exemplarily of both coupling interfaces 18a, 24a, is realized differently from torque transmission elements 54a, 76a, 78a of the at least one of the coupling interfaces 18a, 24a, which are provided for transmitting torque from the tool receiver 20a of the power tool 22a and/or from the tool receiver 26a of the further power tool 28a to the main body 12a.

Preferably, the coupling plane 30a of the coupling interface 18a and the coupling plane 32a of the further coupling interface 24a extend offset from each other and/or tilted with respect to each other by an angle that is other than 0° and 360°. Preferably, the coupling plane 30a of the coupling interface 18a and the coupling plane 32a of the further coupling interface 24a extend without any points of mutual intersection. Preferably, the coupling plane 30a of the coupling interface 18a and the coupling plane 32a of the further coupling interface 24a extend parallel to each other. Preferably, the coupling plane 30a of the coupling interface 18a and/or the coupling plane 32a of the further coupling interface 24a extend/extends parallel to the plane of main extent 66a of the receiving region 16a. Preferably, the coupling plane 30a of the coupling interface 18a and/or the coupling plane 32a of the further coupling interface 24a extend parallel to the plane of main extent 64a of the working region 14a. Preferably, at least one of the coupling interfaces 18a, 24a, in the present exemplary embodiment exemplarily the coupling interface 18a, is closed in itself, in particular in a star shape, in at least one plane extending parallel to the plane of main extent 66a of the receiving region 16a, in particular at least in the plane of main extent 66a of the receiving region 16a.

Preferably, the coupling interface 18a and the further coupling interface 24a have mutually separate axial securing elements 34a, 36a. In particular, the axial securing element 34a of the coupling interface 18a extends outside the coupling plane 32a of the further coupling interface 24a, and the axial securing element 36a of the further coupling interface 24a extends outside the coupling plane 30a of the coupling interface 18a. Preferably, the axial securing element 34a of the coupling interface 18a and the axial securing element 36a of the further coupling interface 24a are realized, in particular shaped, differently from each another. In particular, the axial securing element 34a of the coupling interface 18a and the axial securing element 36a of the further coupling interface 24a are realized without any common sub-portions. In particular, the tool receiver 20a of the power tool 22a, when coupled to the coupling interface 18a, is arranged without contact to the axial securing element 36a of the further coupling interface 24a and, when coupled to the further coupling interface 24a, the tool receiver 26a of the further power tool 28a is arranged without contact to the axial securing element 34a of the coupling interface 18a.

Preferably, the coupling interface 18a and the further coupling interface 24a are spaced from each other. Preferably, the coupling interface 18a and the further coupling interface 24a, in particular at least the axial securing element 34a of the coupling interface 18a and the axial securing element 36a of the further coupling interface 24a, are spaced from each another at least along a direction perpendicular to the plane of main extent 66a of the receiving region 16a, to the coupling plane 30a of the coupling interface 18a and/or to the coupling plane 32a of the further coupling interface 24a. Preferably, the coupling interface 18a and the further coupling interface 24a, in particular at least the axial securing element 34a of the coupling interface 18a and the axial securing element 36a of the further coupling interface 24a, are spaced from each another at least along a direction 44a parallel to the plane of main extent 66a of the receiving region 16a, to the coupling plane 30a of the coupling interface 18a and/or to the coupling plane 32a of the further coupling interface 24a. Preferably, the coupling interface 18a and the further coupling interface 24a are realized without any common elements, in particular axial securing elements 34a, 36a and torque transmission elements 54a, 76a, 78a.

Preferably, the coupling interface 18a and/or the further coupling interface 24a, together with at least one shaped portion 50a of the main body 12a, delimit at least one recess 52a in the main body 12a. Preferably, the shaped portion 50a of the main body 12a, in particular along the direction 44a running parallel to the coupling planes 30a, 32a, is arranged between the coupling interface 18a and the further coupling interface 24a. In particular, the main body 12a in the shaped portion 50a extends transversely with respect to the plane of main extent 66a of the receiving region 16a and/or to the coupling planes 30a, 32a. In particular, the main body 12a in the shaped portion 50a extends at an angle 80a of at least 5°, preferably of at least 10°, particularly preferably of at least 20° and very particularly preferably of at least 30° relative to the plane of main extent 66a of the receiving region 16a and/or to the coupling planes 30a, 32a. In particular, the main body 12a in the shaped portion 50a extends at an angle 80a of at most 90°, preferably of at most 75°, particularly preferably of at most 60° and very particularly preferably of at most 45° relative to the plane of main extent 66a of the receiving region 16a and/or to the coupling planes 30a, 32a. Preferably, the shaped portion 50a spaces the coupling planes 30a, 32a from each other along a direction perpendicular to the coupling planes 30a, 32a. Preferably, the recess 52a extends in the shaped portion 50a. In particular, the recess 52a is directly adjacent to at least one of the coupling interfaces 18a, 24a arranged at the shaped portion 50a. In the present exemplary embodiment, the recess 52a is exemplarily adjacent to the further coupling interface 24a. In particular, the recess 52a is designed, in particular, to expose the at least one of the coupling interfaces 18a, 24a, in the present exemplary embodiment exemplarily the further coupling interface 24a, for coupling to the tool receiver 26a of the further power tool 28a. In particular, the recess 52a extends between the at least one of the coupling interfaces 18a, 24a, in the present exemplary embodiment exemplarily the further coupling interface 24a, and the plane of main extent 66a of the receiving region 16a.

Preferably, at least one of the coupling interfaces 18a, 24a has at least one torque transmission element 54a extending transversely with respect to the coupling planes 30a, 32a. Preferably, the coupling interfaces 18a, 24a comprise a plurality of torque transmission elements 54a, 76a, 78a. Preferably, the torque transmission elements 54a of a single one of the coupling interfaces 18a, 24a, in the present exemplary embodiment exemplarily of the coupling interface 18a, extend transversely with respect to the coupling planes 30a, 32a. In particular, the torque transmission elements 76a of the other of the coupling interfaces 18a, 24a, in the present exemplary embodiment exemplarily of the further coupling interface 24a, extend parallel to the coupling planes 30a, 32a, in particular are arranged in the coupling plane 32a of the other of the coupling interfaces 18a, 24a, in the present exemplary embodiment exemplarily of the further coupling interface 24a. In particular, the coupling interface 18a having the torque transmission elements 54a extending transversely with respect to the coupling planes 30a, 32a has further torque transmission elements 78a extending parallel to the coupling planes 30a, 32a, in particular arranged in the coupling plane 30a of the coupling interface 18a. Preferably, the torque transmission elements 54a extending transversely with respect to the coupling planes 30a, 32a are realized as protrusions 82a and/or indentations 84a in a side wall 86a of at least one of the coupling interfaces 18a, 24a, in the present exemplary embodiment of the coupling interface 18a. Preferably, the torque transmission elements 76a of the further coupling interface 24a and/or the further torque transmission elements 78a of the coupling interface 18a extending parallel to the coupling planes 30a, 32a are realized as recesses, in particular as elongate holes, in the main body 12a and/or in at least one cover wall 88a of at least one of the coupling interfaces 18a, 24a. In the present exemplary embodiment, the torque transmission elements 76a of the further coupling interface 24a are exemplarily realized as recesses, in particular as elongate holes, in the main body 12a, and the further torque transmission elements 78a of the coupling interface 18a are exemplarily realized as recesses, in particular as elongate holes, in the cover wall 88a of the coupling interface 18a. Preferably, the torque transmission elements 54a of the coupling interface 18a extending transversely with respect to the coupling planes 30a, 32a extend along the side wall 86a of at least one of the coupling interfaces 18a, 24a, in the present exemplary embodiment exemplarily of the coupling interface 18a, in particular are formed by the side wall 86a. In particular, the side wall 86a is star-shaped, in particular alternately describing the indentations 84a and protrusions 82a. In particular, the indentations 84a and protrusions 82a in the side wall 86a realize the torque transmission elements 54a of the coupling interface 18a.

FIG. 3 shows the working tool 10a from FIG. 2, when coupled to a power tool 22a of the working system 56a from FIG. 1, in a perspective schematic representation. In particular, the tool receiver 20a of the power tool 22a is shown when coupled to the working tool 10a, in particular to the coupling interface 18a. A counter-axial securing element of the tool receiver 20a of the power tool 22a extends in particular in the coupling interface 18a (not visible here due to the perspective representation). The counter-axial securing element is preferably designed to act in combination with the axial securing element 34a of the coupling interface 18a for the purpose of axially securing the working tool 10a. In particular, the counter-axial securing element is designed to press the working tool 10a, in particular the cover wall 88a, against a press element 90a of the tool receiver 20a of the power tool 22a. The press element 90a comprises, in particular, a plurality of torque transmission extensions. The torque transmission extensions are preferably designed to act in combination with the further torque transmission elements 78a of the coupling interface 18a, for the purpose of transmitting torque to the working tool 10a. In particular, the torque transmission extensions are designed to engage in the further torque transmission elements 78a of the coupling interface 18a.

FIG. 4 shows the working tool 10a from FIG. 2, when coupled to the further power tool 28a of the working system 56a from FIG. 1, in a perspective schematic representation. In particular, the tool receiver 26a of the further power tool 28a is shown when coupled to the working tool 10a, in particular to the further coupling interface 24a. A counter-axial securing element 92a of the tool receiver 26a of the further power tool 28a presses in particular the further coupling interface 24a, in particular the main body 12a, against a press element 94a of the tool receiver 26a of the further power tool 28a. The counter-axial securing element 92a of the tool receiver 26a of the further power tool 28a preferably extends, at least portionally, through the recess 52a in the shaped portion 50a. The tool receiver 26a of the further power tool 28a is fed to the further coupling interface 24a, in particular, through a tool-receiver feed opening 48a of the further coupling interface 24a (cf. FIG. 2). Preferably, the coupling interface 18a has a tool-receiver feed opening 46a and a further tool-receiver feed opening 96a (cf. FIG. 2). In particular, the tool-receiver feed opening 46a of the coupling interface 18a merges, in the coupling plane 30a of the coupling interface 18a, into the further tool-receiver feed opening 96a of the coupling interface 18a.

Described in the following, in particular with reference to FIG. 2, is a method for the production of a working tool, in particular the aforementioned working tool 10a. Preferably, in at least one method step, at least two, in particular different, in particular the aforementioned, coupling interfaces 18a, 24a are arranged on the main body 12a, in a receiving region 16a, in particular aforementioned, of the main body 12a that is different in particular from the aforementioned working region 14a of at least one main body 12a, in particular the aforementioned, of the working tool 10a, such that the coupling interfaces 18a, 24a realize at least two different coupling planes 30a, 32a, in particular the aforementioned, in each of which at least one axial securing element 34a, 36a, in particular the aforementioned, of the coupling interface 18a and/or of the further coupling interface 24a is arranged. Preferably, the coupling interfaces 18a, 24a are arranged on the main body 12a with different transverse extents transverse to the plane of main extent 66a of the receiving region 16a. In particular, the coupling interfaces 18a, 24a are realized integrally with the main body 12a. Preferably, the main body 12a and the coupling interfaces 18a, 24a are formed from a common blank, in particular from a metal, preferably from a steel. In particular, the coupling interfaces 18a, 24a are formed by a forming process, by a casting process, by a stamping process, by a milling process or the like. Alternatively, it is conceivable for the coupling interfaces 18a, 24a to be formed integrally with the main body 12a by a 3D printing process.

Preferably, in at least one further method step, at least one recess, in particular realized as a tool-receiver feed opening 46a, 48a, is made in the main body 12a and/or in at least one of the coupling interfaces 18a, 24a by means of a laser-cutting and/or water-jet cutting process. Preferably, the at least one recess, in particular realized as a tool-receiver feed opening 46a, 48a, is made in the main body 12a and/or in at least one side wall 86a of at least one of the coupling interfaces 18a, 24a. In particular, at least a portion of the main body 12a and/or at least a portion of the at least one side wall 86a is cut out by means of a laser beam and/or by means of a water jet in order to realize the at least one recess, in particular realized as a tool-receiver feed opening 46a, 48a. In the present exemplary embodiment, a recess realized as the tool-receiver feed opening 46a of the coupling interface 18a is exemplarily made in the coupling interface 18a, in particular in the side wall 86a of the coupling interface 18a, and a recess realized as the tool-receiver feed opening 48a of the further coupling interface 24a is exemplarily made in the further coupling interface 24a, in particular in the main body 12a. In respect of further method steps of the method for the production of the working tool 10a, reference may be made to the preceding description of the working tool 10a, since this description is to be construed as also analogous to the method, and consequently all features in respect of the working tool 10a are also deemed as disclosed with regard to the method for the production of the working tool 10a.

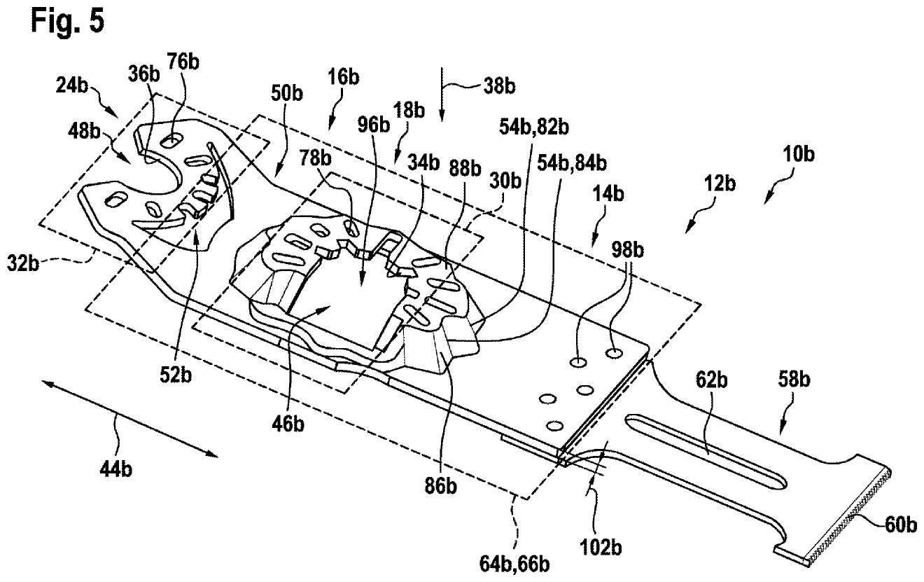

FIGS. 5 to 13 show nine further exemplary embodiments of the invention. The following descriptions and the drawings are limited substantially to the differences between the exemplary embodiments and, in principle, reference may also be made to the drawings and/or the description of the other exemplary embodiments, in particular of FIGS. 1 to 4, in respect of components having the same reference numbers. To distinguish the exemplary embodiments, the letter a has been appended to the reference numbers of the exemplary embodiment in FIGS. 1 to 4. In the exemplary embodiments of FIGS. 5 to 13, the letter a is replaced by the letters b to j. FIG. 5 shows a first alternative working tool 10b, in a perspective schematic representation. The working tool 10b is, in particular, largely similar in design to the working tool 10a of the first exemplary embodiment, except for an orientation of a coupling interface 18b of the working tool 10b and a working region 14b of a main body 12b of the working tool 10b. In particular, the main body 12b of the working tool 10b is riveted in the working region 14b of the main body 12b to a working part 58b of the working tool 10b, in particular as an alternative to a welded connection. Preferably, the working tool 10b comprises a plurality of riveted joints 98b between the main body 12b and the working part 58b, in particular in the working region 14b. Alternatively and preferably, it is conceivable for the main body 12b and the working part 58b to be connected to each other by a material bond, for example welded, soldered or the like. In comparison with the first exemplary embodiment, the coupling interface 18b of the working tool 10b, in particular a tool-receiver feed opening 46b of the coupling interface 18b, is preferably arranged on the main body 12b rotated by 90°, in particular in a plane of main extent 66b of a receiving region 16b of the main body 12b. In particular, the plane of main extent 66b of the receiving region 16b and a plane of main extent 64b of the working region 14b coincide. In particular, the main body 12b is realized without any transition region.

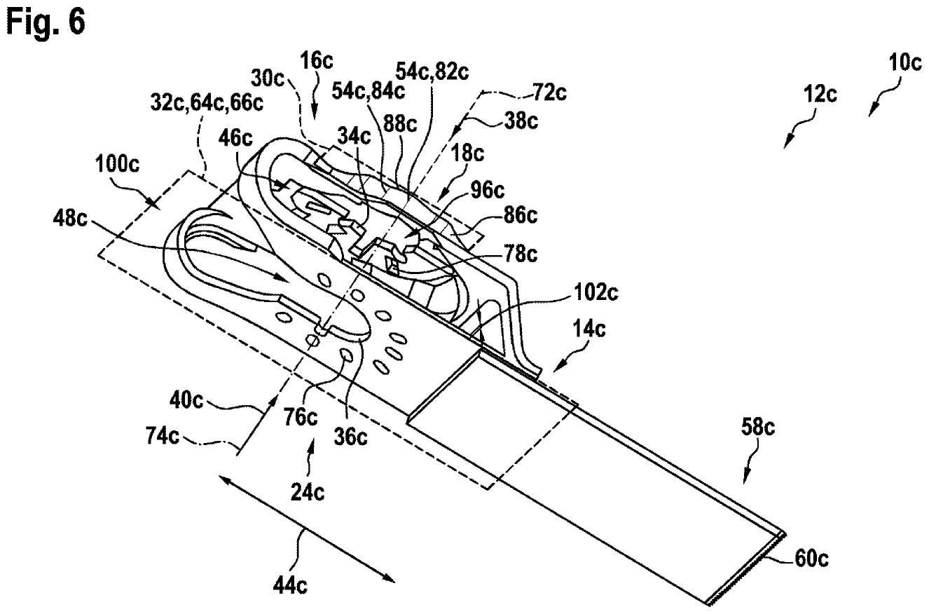

FIG. 6 shows a second alternative working tool 10c, in a perspective schematic representation. The working tool 10c comprises in particular a main body 12c, a coupling interface 18c for coupling to a power tool, and a further coupling interface 24c for coupling to a further power tool. Preferably, the coupling interface 18c realizes a coupling plane 30c, and the further coupling interface 24c realizes a coupling plane 32c. Preferably, the coupling interface 18c and the further coupling interface 24c are arranged so as to overlap, in least portionally. Preferably, the coupling interface 18c and the further coupling interface 24c are arranged so as to overlap, at least portionally, as viewed at least along one direction, in particular along coupling directions 38c, 40c, perpendicular to the coupling planes 30c, 32c. In particular, the coupling interface 18c and the further coupling interface 24c are arranged spaced from each other at least along the direction, in particular along the coupling directions 38c, 40c, perpendicular to the coupling planes 30c, 32c. Preferably, the coupling interface 18c and the further coupling interface 24c are arranged parallel to the coupling planes 30c, 32c along a direction 44c, in particular along a plurality of different directions 44c, without being spaced from each other. Preferably, the coupling plane 30c of the coupling interface 18c or the coupling plane 32c of the further coupling interface 24c, in the present exemplary embodiment exemplarily the coupling plane 32c of the further coupling interface 24c, corresponds to a plane of main extent 66c of a receiving region 16c of the main body 12c.

Preferably, the main body 12c is shaped in the manner of a bellows, in particular to realize an at least portionally overlapping arrangement of the coupling interface 18c and the further coupling interface 24c. In particular, the main body 12c in the receiving region 16c is shaped in the manner of a bellows. In particular, the main body 12c in the receiving region 16c has a shaped region 100c by which the coupling interface 18c and the further coupling interface 24c are spaced from each other. Preferably, the main body 12c is shaped by an angle of at least 90°. Preferably, the main body 12c is shaped in a rounded manner. In particular, the main body 12c does not have any sharp bend in the shaped region 100c. In the shaped region 100c, the main body 12c is preferably realized in a manner substantially similar to a shaped portion of a bellows.

Preferably, the coupling interface 18c and the further coupling interface 24c are arranged coaxially with respect to each other. In particular, an axial securing element 34c of the coupling interface 18c and an axial securing element 36c of the further coupling interface 24c are arranged congruently with each other as viewed along the direction, in particular along the coupling directions 38c, 40c, perpendicular to the coupling planes 30c, 32c. In particular, further torque transmission elements 78c of the coupling interface 18c and torque transmission elements 76c of the further coupling interface 24c may be arranged congruently with each other as viewed parallel to the direction, in particular parallel to the coupling directions 38c, 40c, perpendicular to the coupling planes 30c, 32c. Preferably, an output axis 72c of a tool receiver coupled to the coupling interface 18c is coaxial, in particular congruent, with an output axis 74c of a tool receiver coupled to the further coupling interface 24c.

Preferably, the coupling interface 18c and the further coupling interface 24c are arranged in such a manner that the coupling interface 18c and the further coupling interface 24c can be coupled to a power tool, in particular to the aforementioned power tool and to the further power tool, in mutually antiparallel, in particular in the aforementioned, coupling directions 38c, 40c. Preferably, the coupling interface 18c and the further coupling interface 24c are arranged in such a manner that the coupling interface 18c and the further coupling interface 24c can be coupled to a power tool in mutually anticoaxial coupling directions 38c, 40c. In particular, at least one of the coupling interfaces 18c, 24c, in the present exemplary embodiment exemplarily the coupling interface 18c, may have a transverse extent, in particular a side wall 86c, that extends beyond a material thickness 102c of the main body 12c, in particular in the receiving region 16c.

Preferably, the transverse extent, in particular the side wall 86c, of the at least one of the coupling interfaces 18c, 24c, in the present exemplary embodiment exemplarily the coupling interface 18c, extends along a direction away from the respectively other of the coupling interfaces 18c, 24c, in the present exemplary embodiment exemplarily the further coupling interface 24c. Preferably, the coupling interface 18c and the further coupling interface 24c, arranged so as to overlap at least portionally, are arranged in such a manner that the coupling interface 18c and the further coupling interface 24c can be coupled to a power tool in mutually antiparallel coupling directions 38c, 40c. In the present exemplary embodiment, the coupling interface 18c can exemplarily be coupled to the power tool along the coupling direction 38c, and the further coupling interface 24c can exemplarily be coupled to the further power tool along a further coupling direction 40c.

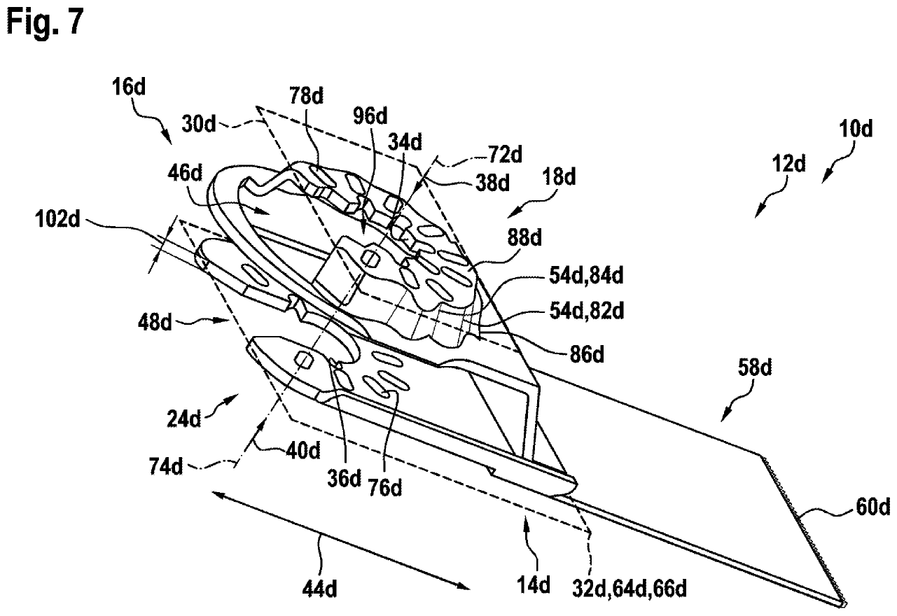

FIG. 7 shows a third alternative working tool 10d, in a perspective schematic representation. The working tool 10d comprises in particular a main body 12d, a coupling interface 18d for coupling to a power tool, and a further coupling interface 24d for coupling to a further power tool. The working tool 10d is, in particular, largely similar in design to the working tool 10c of the exemplary embodiment shown in FIG. 6, with the exception of a shaped region of the main body 12d of the working tool 10d. Preferably, the main body 12d of the working tool 10d does not have any shaped region. In particular, the coupling interface 18c is attached to the main body 12d in a working region 14d of the main body 12d, in particular welded to the main body 12d.

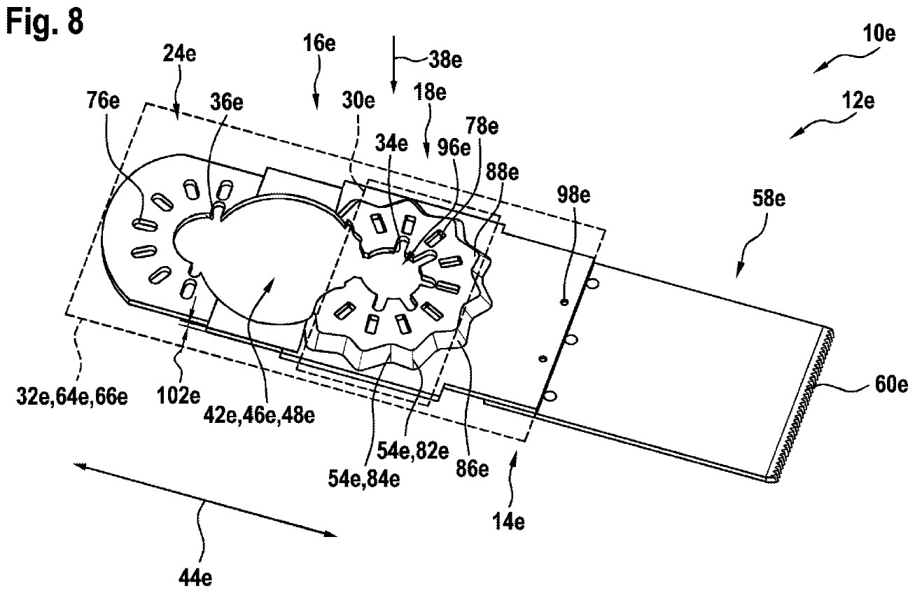

FIG. 8 shows a fourth alternative working tool 10e, in a perspective schematic representation. The working tool 10e comprises in particular a main body 12e, a coupling interface 18e for coupling to a power tool, and a further coupling interface 24e for coupling to a further power tool. Preferably, the coupling interface 18e realizes a coupling plane 30e, and the further coupling interface 24e realizes a coupling plane 32e. Preferably, the main body 12e delimits at least one recess 42e that spaces the coupling interface 18e and the further coupling interface 24e from each other, at least in a direction 44e parallel to the coupling planes 30e, 32e. Preferably, the recess 42e is arranged in a receiving region 16e of the main body 12e, in particular extends in a plane of main extent 66e of the receiving region 16e. In particular, the recess 42e extends in the coupling plane 32e of the further coupling interface 24e. Preferably, the coupling plane 32e of the further coupling interface 24e and the plane of main extent 66e of the receiving region 16e coincide. In particular, the further coupling interface 24e has a transverse extent corresponding to a material thickness 102e of the main body 12e, in particular in the receiving region 16e. Preferably, the recess 42e is circular. Alternatively, it is conceivable for the recess 42e to be elliptical, polygonal or realized in another manner considered appropriate by persons skilled in the art. Preferably, the coupling interface 18e and/or the further coupling interface 24e, in the present exemplary embodiment exemplarily the coupling interface 18e and the further coupling interface 24e, are/is arranged directly adjacent to the recess 42e, in particular on opposite sides of the recess 42e, in the direction 44e parallel to the coupling planes 30e, 32e.

Preferably, the recess 42e serves as a combined tool-receiver feed opening 46e, 48e for the coupling interface 18e and for the further coupling interface 24e. In particular, a tool receiver can be guided along a direction, in particular along a coupling direction 38e, perpendicular to the plane of main extent 66e of the receiving region 16e and/or to the coupling planes 30e, 32e, at least portionally, through the recess 42e. In particular, the tool receiver arranged at least portionally in the recess 42e is displaceable along and/or contrary to the direction 44e that is parallel to the coupling planes 30e, 32e, in particular perpendicularly in relation to the coupling direction 38e, in particular for the purpose of engagement with the coupling interface 18e and/or with the further coupling interface 24e. Preferably, the recess 42e merges into an axial securing element 34e of the coupling interface 18e and/or into an axial securing element 36e of the further coupling interface 24e, in particular along and/or contrary to the direction 44e that is parallel to the coupling planes 30e, 32e.

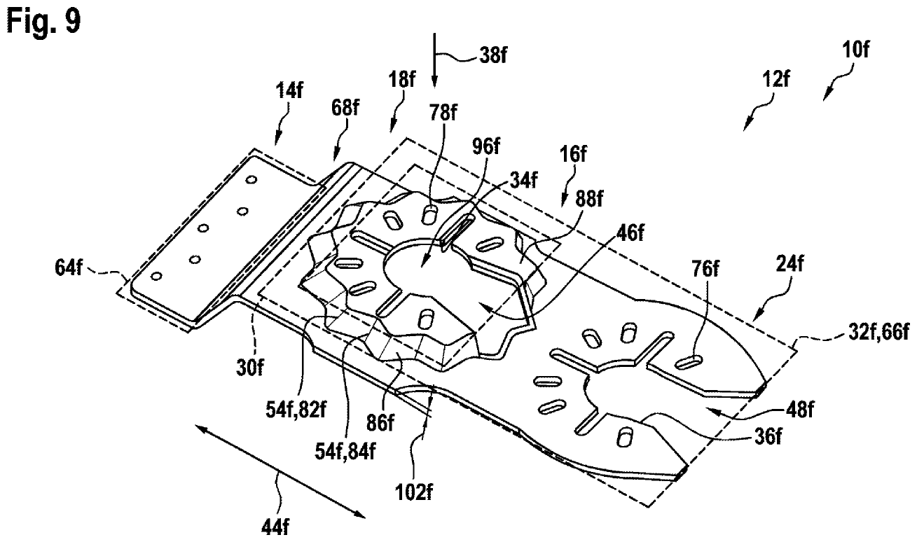

FIG. 9 shows a fifth alternative working tool 10f, in a perspective schematic representation. The working tool 10f comprises in particular a main body 12f, a coupling interface 18f for coupling to a power tool, and a further coupling interface 24f for coupling to a further power tool. Preferably, the coupling interface 18f realizes a coupling plane 30f, and the further coupling interface 24f realizes a coupling plane 32f. In particular, the coupling plane 32f of the further coupling interface 24f coincides with a plane of main extent 66f of a receiving region 16f of the main body 12f. Preferably, a plane of main extent 64f of a working region 14f of the main body 12f is different from the plane of main extent 66f of the receiving region 16f and extends parallel to the plane of main extent 66f of the receiving region 16f. The coupling interface 18f has in particular a star-shaped sidewall 86f having protrusions 82f and indentations 84f that realize torque transmission elements 54f extending transversely with respect to the coupling planes 30f, 32f. Preferably, the coupling interface 18f has a tool-receiver feed opening 46f and a further tool-receiver feed opening 96f. For reasons of clarity, a working part of the working tool 10h is not represented.

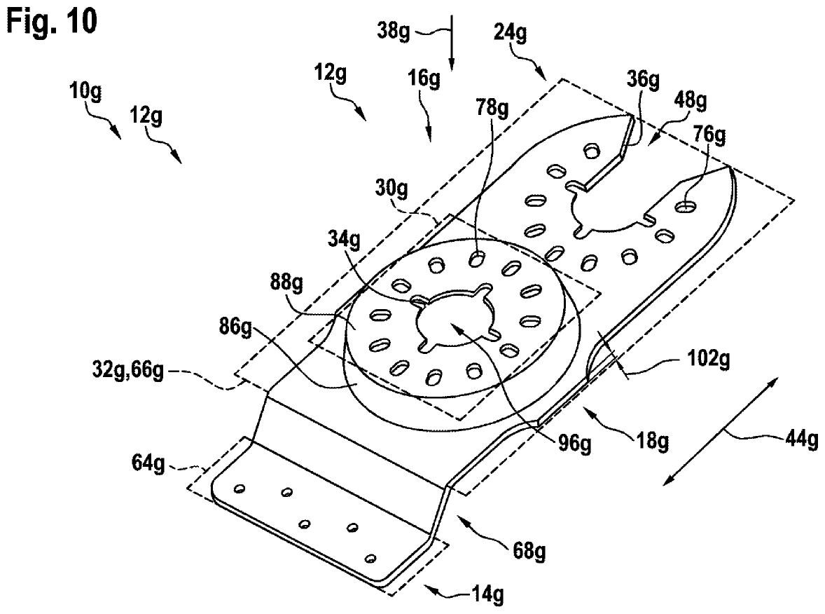

FIG. 10 shows a sixth alternative working tool 10g, in a perspective schematic representation. The working tool 10g comprises in particular a main body 12g, a coupling interface 18g for coupling to a power tool, and a further coupling interface 24g for coupling to a further power tool. Preferably, the coupling interface 18g realizes a coupling plane 30g, and the further coupling interface 24g realizes a coupling plane 32g. The working tool 10g is, in particular, largely similar in design to the working tool 10f of the exemplary embodiment shown in FIG. 9, with the exception of the coupling interface 18g. The coupling interface 18g has in particular an annular side wall 86g that does not have any torque transmission elements extending transversely with respect to the coupling planes 30g, 32g. In particular, the coupling interface 18g has a further tool-receiver feed opening 96g and does not have any tool-receiver feed opening adjoining the further tool-receiver feed opening 96g. For reasons of clarity, a working part of the working tool 10h is not represented.

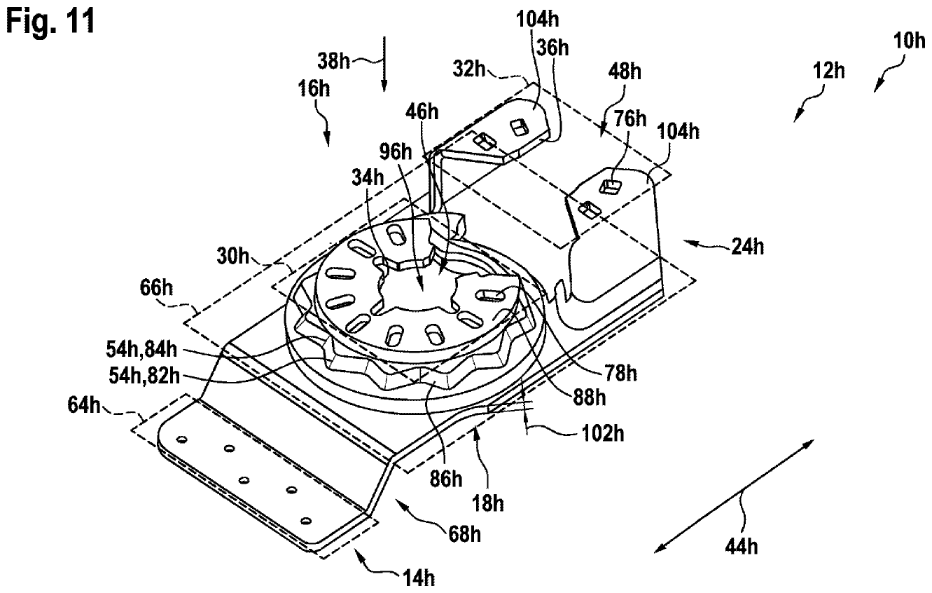

FIG. 11 shows a seventh alternative working tool 10h, in a perspective schematic representation. The working tool 10h comprises in particular a main body 12h, a coupling interface 18h for coupling to a power tool, and a further coupling interface 24h for coupling to a further power tool. Preferably, the coupling interface 18h realizes a coupling plane 30h, and the further coupling interface 24h realizes a coupling plane 32h. The coupling interface 18h preferably has a star-shaped side wall 86h and an annular cover wall 88h. In particular, the coupling interface 18h has a stepped shape as viewed along a direction, in particular along a coupling direction 38h, perpendicular to the coupling planes 30h, 32h. The further coupling interface 24h comprises in particular two coupling interface sub-portions 104h. The coupling interface sub-portions 104h are preferably arranged symmetrically with respect to each another in the coupling plane 32h of the further coupling interface 24h. In particular, the coupling interface sub-portions 104h, in particular in the coupling plane 32h of the further coupling interface 24h, are arranged without connection to each another. For reasons of clarity, a working part of the working tool 10h is not represented.

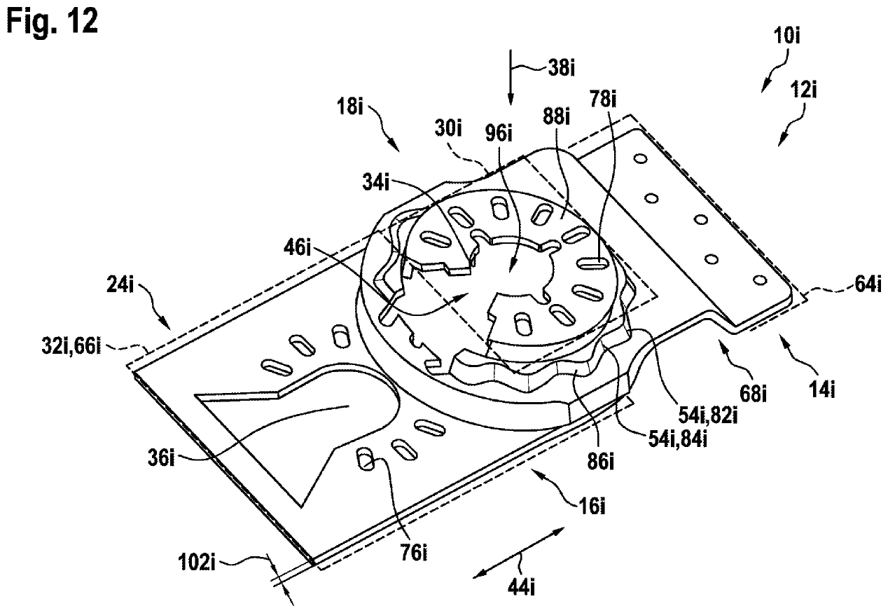

FIG. 12 shows an eighth alternative working tool 10i, in a perspective schematic representation. The working tool 10h comprises in particular a main body 12h, a coupling interface 18h for coupling to a power tool, and a further coupling interface 24h for coupling to a further power tool. Preferably, the coupling interface 18i realizes a coupling plane 30i, and the further coupling interface 24i realizes a coupling plane 32i. The coupling interface 18i preferably has a side wall 86i which, as viewed along a direction, in particular along a coupling direction 38i, perpendicular to the coupling planes 30i, 32i, is portionally annular and portionally star-shaped. Preferably, the coupling interface 18i has an annular cover wall 88i. In particular, the coupling interface 18i has a stepped shape along the direction, in particular along the coupling direction 38i, perpendicular to the coupling planes 30i, 32i. The further coupling interface 24i is in particular closed in itself in the coupling plane 32i of the further coupling interface 24i. In particular, the coupling plane 32i of the further coupling interface 24i, a plane of main extent 66i of a receiving region 16i of the main body 12i and a plane of main extent 64i of a working region 14i of the main body 12i coincide. For reasons of clarity, a working part of the working tool 10h is not represented.

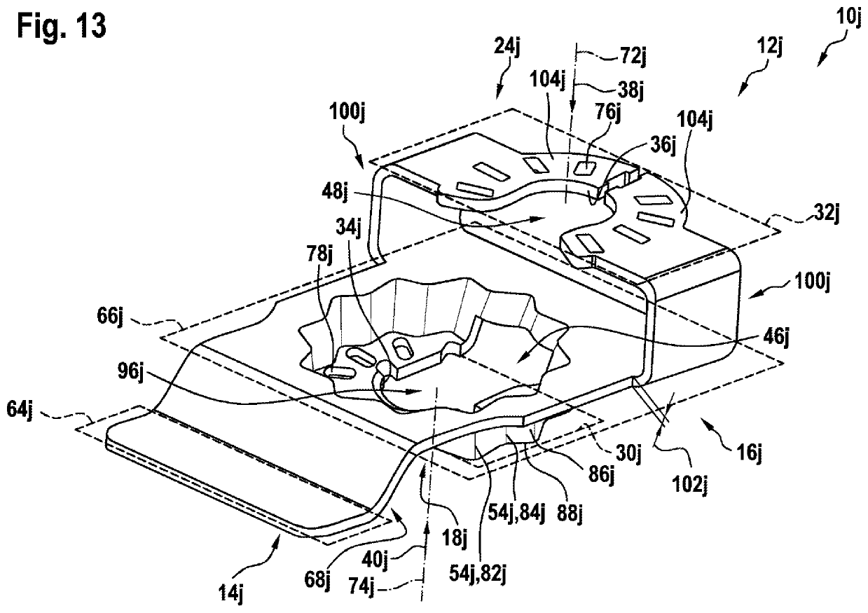

FIG. 13 shows a ninth alternative working tool 10j, in a perspective schematic representation. The working tool 10j comprises in particular a main body 12j, a coupling interface 18j for coupling to a power tool, and a further coupling interface 24j for coupling to a further power tool. Preferably, the coupling interface 18j realizes a coupling plane 30j, and the further coupling interface 24j realizes a coupling plane 32j. The coupling interface 18j and the further coupling interface 24j can preferably be coupled to a power tool in antiparallel coupling directions 38j, 40j. In particular, the further coupling interface 24j comprises two coupling interface sub-portions 104j. Preferably, the further coupling interface 24j, in particular the coupling interface sub-portions 104j, is/are spaced from the coupling interface 18j by shaped regions 100j of the main body 12j.

A side wall 86j of the coupling interface 18j preferably extends away from the further coupling interface 24j, contrary to the coupling direction 38j.

1. A working tool, in particular an oscillating working tool, comprising:
at least one main body, comprising
at least one coupling interface, arranged on the at least one main body in a receiving region of the at least one main body that is different from a working region of the at least one main body, the at least one coupling interface configured to couple to a tool receiver of a power tool, and
at least one further coupling interface, arranged in the receiving region on the at least one main body, the at least one further coupling interface configured to couple to a further tool receiver, different from the tool receiver, of a further power tool, wherein the at least one coupling interface and the at least one further coupling interface realize at least two different respective coupling planes, in each of which at least one axial securing element of the at least one coupling interface and/or of the further coupling interface is arranged.

2. The working tool as claimed in claim 1, wherein the at least one coupling interface and the at least one further coupling interface have mutually separate axial securing elements.

3. The working tool as claimed in claim 1, wherein the at least one coupling interface and the at least one further coupling interface are spaced from each other.

4. The working tool as claimed in claim 1, wherein the at least one coupling interface and the at least one further coupling interface are arranged so as to overlap, at least portionally.

5. The working tool as claimed in claim 1, wherein the main body is shaped in the manner of a bellows, such that an at least portionally overlapping arrangement of the at least one coupling interface and the at least one further coupling interface is realized.

6. The working tool as claimed in claim 1, wherein the at least one coupling interface and the at least one further coupling interface are arranged coaxially with respect to each other.

7. The working tool as claimed in claim 1, wherein the at least one coupling interface and the at least one further coupling interface are arranged such that the at least one coupling interface and the at least one further coupling interface are configured to couple to a power tool in mutually antiparallel coupling directions.

8. The working tool as claimed in claim 1, wherein the main body delimits at least one recess that spaces the at least one coupling interface and the at least one further coupling interface from each other, at least in a direction parallel to the respective coupling planes.

9. The working tool as claimed in claim 8, wherein the at least one recess is configured as a combined tool-receiver feed opening for the at least one coupling interface and for the at least one further coupling interface.

10. The working tool as claimed in claim 1, wherein the at least one coupling interface and/or the at least one further coupling interface, together with at least one shaped portion of the main body, delimit/delimits at least one recess in the main body.

11. The working tool as claimed in claim 1, wherein at least one of the at least one coupling interfaces has at least one torque transmission element extending transversely with respect to the respective coupling planes.

12. A working system comprising:
at least one working tool as claimed in claim 1; and
at least one oscillating power tool, and/or at least one further oscillating power tool, wherein the at least one oscillating power tool and/or the at least one further oscillating power tool have/has at least one tool receiver configured to couple with the at least one working tool using the at least one coupling interface, wherein the at least one oscillating power tool and/or the at least one further oscillating power tool have/has at least one further tool receiver that is realized differently from the at least one tool receiver and to which the at least one working tool is couplable using the at least one further coupling interface.

13. A method for the production of a working tool comprising
at least one main body, comprising
at least one coupling interface, arranged on the at least one main body in a receiving region of the at least one main body that is different from a working region of the at least one main body, the at least one coupling interface configured to couple to a tool receiver of a power tool, and
at least one further coupling interface, arranged in the receiving region on the at least one main body, the at least one further coupling interface configured to couple to a further tool receiver, different from the tool receiver, of a further power tool, wherein the at least one coupling interface and the at least one further coupling interface realize at least two different coupling planes, in each of which at least one axial securing element of the at least one coupling interface and/or of the further coupling interface is arranged,
the method comprising:
arranging at least two different, coupling interfaces in a receiving region of the at least one main body that is different from a working region of the at least one main body of the working tool, such that the two coupling interfaces realize the at least two different respective coupling planes, in each of which at least one axial securing element of the at least one coupling interface and/or of the at least one further coupling interface is arranged.

14. The method as claimed in claim 13, further comprising:
forming at least one recess configured as a tool-receiver feed opening in at least one of the at least one main body, the at least one coupling interface, and the at least one further coupling interface using at least one of a laser-cutting and a water-jet cutting process.
